(19) United States
(12) Patent Application Publication
(10) Pub. No.: US 2010/0183158 A1
(43) Pub. Date: Jul. 22, 2010

(54) APPARATUS, SYSTEMS AND METHODS FOR BINAURAL HEARING ENHANCEMENT IN AUDITORY PROCESSING SYSTEMS

(76) Inventors: Simon Haykin, Ancaster (CA); Karl Wiklund, Hamilton (CA)

Correspondence Address: BERESKIN AND PARR LLP/S.E.N.C.R.L., s.r.l., 40 KING STREET WEST, BOX 401, TORONTO, ON, M5H 3Y2, CA

(21) Appl. No.: 12/637,001

(22) Filed: Dec. 14, 2009

Related U.S. Application Data
(60) Provisional application No. 61/121,949, filed on Dec. 12, 2008.

(51) Int. Cl. H04R 25/00

(52) U.S. Cl. 381/23.1

(57) ABSTRACT

According to one aspect, a system for binaural hearing enhancement, including at least one auditory receiver and at least one processor coupled to the at least one auditory receiver. The at least one auditory receiver is configured to receive an auditory signal that includes a target signal. The at least one processor configured to extract a plurality of auditory cues from the auditory signal, prioritize at least one of the plurality of auditory cues based on the robustness of the auditory cues, and based on the prioritized auditory cues, extract the target signal from the auditory signal.

### RELATED APPLICATIONS

This application claims the benefit of U.S. Provisional Patent Application Ser. No. 61/121,949 filed on Dec. 12, 2008 and entitled APPARATUS, SYSTEMS AND METHODS FOR BINAURAL HEARING ENHANCEMENT IN AUDITORY PROCESSING SYSTEMS, the entire contents of which are incorporated herein by reference for all purposes.

### TECHNICAL FIELD

The teachings disclosed herein relates to auditory processing systems, and in particular to apparatus, systems and methods for binaural hearing enhancement in auditory processing systems such as hearing aids.

### INTRODUCTION

The human auditory system is remarkable in its ability to process sound in challenging environments. For example, the human auditory system can detect quiet sounds while tolerating sounds millions of times more intense, and can discriminate time differences of several microseconds. The human auditory system is also highly skilled at performing auditory scene analysis, whereby the auditory system separates complex signals impinging on the ears into component sounds representing the outputs of different sound sources in the surrounding environment.

However, with hearing loss the auditory source separation capability of the human auditory system can break down, resulting in an inability to understand speech in noise. One manifestation of this situation is known as the “cocktail party problem” in which a hearing impaired person has difficulty understanding speech in a noisy room, particularly when the background noise includes competing speech sources.

In spite of the ease with which most human auditory systems can cope in such a noisy environment, it has proven to be a very difficult problem to solve computationally. For example, the non-stationarity of both the source of interest and the interference signals often makes it difficult to form proper statistical estimates, or to know when a proposed algorithm should enter an adaptive or non-adaptive phase.

Furthermore, in the case of speech-on-speech interference, both the desired source and the interferers tend to have similar long-term statistical structure and occupy the same frequency bands, making filtering difficult. Conventional spatial processing systems are also inadequate given limitations of a binaural configuration and due to the fact that such systems tend to perform poorly in reverberant environments.

Accordingly, the inventors have recognized a need for improved apparatus, systems, and methods for processing auditory signals in auditory processing systems such as hearing aids.

### SUMMARY OF SOME EMBODIMENTS

According to one aspect, there is provided a system for binaural hearing enhancement, the system configured to receive an auditory signal including a target signal, perform time-frequency decomposition on the auditory signal, extract a plurality of auditory cues from the auditory signal, prioritize at least one of the plurality of auditory cues based on the robustness of each auditory cue, and based on the prioritized cues, extract the target signal from the auditory signal.

The system may be configured to determine cue identities using fuzzy logic, group the auditory cues based on cue priorities, calculate time-frequency weighting factors for the at least one auditory cues, calculate at least one smoothing parameter, and perform time-smoothing over time-frequency weighting factors based on the at least one smoothing parameter.

The system may be configured to reduce and/or modify rearwards directional interference using spectral subtraction weights derived from at least one rearward facing microphone. The system may be configured to re-synthesize the interference reduced signal and to output the resulting interference reduced signal to a user.

The time-frequency decomposition may be performed using at least one gamma-tone filter. In some embodiments, other filter bank types may be used. In some cases, many filters (e.g. sixteen or more) may be required to achieve a desired resolution.

The plurality of auditory cues includes at least one of an onset cue, a pitch cue, an interaural time delay (ITD) cue, and an interaural intensity difference (IID) cue.

The system may be portable, and may be configured to be worn by the user.

According to another aspect, there is provided a method for binaural hearing enhancement, comprising receiving an auditory signal including a target signal, performing time-frequency decomposition on the auditory signal, extracting a plurality of auditory cues from the auditory signal, prioritizing at least one of the plurality of auditory cues based on the robustness of each auditory cue, and based on the prioritized cues, extracting an interference reduced signal approximating the target signal from the auditory signal.

The method may further include determining cue identities using fuzzy logic, grouping the auditory cues based on cue priorities, calculating time-frequency weighting factors for the at least one auditory cues, calculating at least one smoothing parameter, and performing time-smoothing over time-frequency weighting factors based on the at least one smoothing parameter.

The method may further include reducing and/or modifying rearwards directional interference using spectral subtraction weights derived from at least one rearward-facing microphone, which may be a directional microphone. The method may further include re-synthesizing the interference reduced signal and outputting the resulting interference reduced signal to a user. The time-frequency decomposition may be performed using at least one gamma-tone filter. The plurality of auditory cues includes at least one of an onset cue, a pitch cue, an interaural time delay (ITD) cue, and an interaural intensity difference (IID) cue.

According to another aspect, there is provided an apparatus for binaural hearing enhancement comprising at least one forward-facing microphone and at least one rearward-facing microphone, each microphone coupled to a FCPP configured to receive an auditory signal from the microphones including a target signal, perform time-frequency decomposition on the auditory signal, extract a plurality of auditory cues from the auditory signal, prioritize at least one of the plurality of auditory cues based on the robustness of each auditory cue, and based on the prioritized cues, extract the target signal from the auditory signal.

In some embodiments, the apparatus includes at least two forward-facing microphones and at least two rearward-facing microphones.

The forward-facing microphones and rearward-facing microphones may be directional microphones.

The forward-facing microphones and rearward-facing microphones may be spaced apart by an operational distance. In some embodiments, the operational distance may be selected such that the forward-facing microphones and rearward-facing microphones are spaced apart by a predetermined distance.

In other embodiments, the operational distance may be selected such that the forward-facing microphones and two rearward-facing microphones are close together. In some embodiments, wherein the FCPP incorporates coherent ICA, the forward-facing microphones and two rearward-facing microphones may be provided as close together as practically possible.

According to yet another aspect, there is provided a system for binaural hearing enhancement, comprising at least one auditory receiver configured to receive an auditory signal that includes a target signal, at least one processor coupled to the at least one auditory receiver, the at least one processor configured to: extract a plurality of auditory cues from the auditory signal, prioritize at least one of the plurality of auditory cues based on the robustness of the auditory cues, and based on the prioritized auditory cues, extract the target signal from the auditory signal.

The at least one processor may be configured to extract the target signal by performing time-frequency decomposition on the auditory signal.

The plurality of auditory cues may include at least one of: onset cues, pitch cues, interaural time delay (ITD) cues, and interaural intensity difference (IID) cues.

The onset cues and pitch cues may be considered as robust cues, while the ITD cues and IID cues are considered as weaker cues, and the at least one processor may be configured to: make initial auditory groupings using the robust cues; and then specifically identify the auditory groupings using the weaker cues.

The at least one processor may be further configured to: group the auditory cues based on one or more fuzzy logic operations; and analyze the groups to extract the target signal.

The at least one processor may be further configured to: calculate time-frequency weighting factors for the plurality of auditory cues; calculate at least one smoothing parameter; and perform time-smoothing over the time-frequency weighting factors based on the at least one smoothing parameter.

The at least one auditory receiver may include at least one pair of forward facing microphones and at least one pair of rearward facing microphones. The at least one processor may be further configured to reduce rearwards directional interference using spectral subtraction weights derived from the at least one pair of rearward facing microphones. The at least one processor may be configured to re-synthesize the interference reduced signal and to output the resulting interference reduced signal to at least one output device.

The system may further comprise a pre-processor configured to eliminate at least some interference from the auditory signal before the auditory signal is received by the at least one processor. The pre-processor may be configured to perform independent component analysis (ICA) on the auditory signal before the auditory signal is received by the at least one processor, and wherein the at least one auditory receiver includes two closely spaced microphones.

The pre-processor may be configured to perform coherent independent component analysis (CICA) on the auditory signal before the auditory signal is received by the at least one processor.

The pre-processor may be configured to perform copula independent components analysis (coICA) on the auditory signal before the auditory signal is received by the at least one processor.

According to another aspect, there is provided a method for binaural hearing enhancement, comprising receiving an auditory signal that includes a target signal, extracting a plurality of auditory cues from the auditory signal, prioritizing at least one of the plurality of auditory cues based on the robustness of the auditory cues, and based on the prioritized auditory cues, extracting the target signal from the auditory signal. The target signal may be extracted by performing time-frequency decomposition on the auditory signal.

According to yet another aspect, there is provided an apparatus for binaural hearing enhancement, comprising: at least one auditory receiver configured to receive an auditory signal that includes a target signal, and at least one processor coupled to the at least one auditory receiver, the at least one processor configured to: extract a plurality of auditory cues from the auditory signal, prioritize at least one of the plurality of auditory cues based on the robustness of the auditory cues, and based on the prioritized auditory cues, extract the target signal from the auditory signal.

The auditory signal may include the target signal and at least one interfering signal.

### BRIEF DESCRIPTION OF THE DRAWINGS

The drawings included herewith are for illustrating various examples of systems, methods, and apparatuses of the present specification and are not intended to limit the scope of what is taught in any way. In the drawings:

FIG. 1 is a graphical representation of interaural time difference (ITD) lags in an example reverberant environment with one target at 0° and no interfering signals;

FIG. 2 is a graphical representation of ITD lags in the same reverberant environment as in FIG. 1, but with no target signal and three interferers (located at 67°, 135°, and 270°;

FIG. 3 is a graphical representation of ITD lags in another example environment for three interferers with a Signal to Interference Ratio (SIR) at 0 dB showing a strong clustering near 0 time lag;

FIG. 4 is a graphical representation of the distribution of interaural intensity difference (IID) cues in a highly reverberant environment with no interferers;

FIG. 5 is a graphical representation of the IID distribution for three interferers in a highly reverberant environment with a SIR of 0 dB;

FIG. 6 is a graphical representation of the IID distribution for three interferers and no signal in a highly reverberant environment;

FIG. 7 is a graphical representation of a speech envelope and onset plot of the speech envelop for a single channel according to one example;

FIG. 8 is a schematic diagram showing the formation of a binary mask using logical operations according to one embodiment;

FIG. 9 is a flowchart showing a method of processing input envelopes exhibiting an onset period according to one embodiment;

FIG. 10 is a flowchart showing a method of processing for non-onset periods according to one embodiment;

FIG. 11 is a graphical representation of a membership function for use with symmetric relations according to one embodiment;

FIG. 12 is a graphical representation of a limiting function for use in implementing a fuzzy logic “most” membership function according to one embodiment;

FIG. 13 is a graphical representation of a target signal recording in a reverberant environment;

FIG. 14 is a graphical representation of a signal recording including the target signal with three interfering speech sources in a reverberant environment;

FIG. 14A is a schematic representation of the target signal and interfering speech sources in the environment of FIG. 14;

FIG. 15 is a graphical representation of an estimated target signal based on the signal recording of FIG. 14 using a non-fuzzy Cocktail Party Processor (CPP) according to one embodiment;

FIG. 16 is a graphical representation of an estimated target signal based on the signal recording of FIG. 14 using a fuzzy CPP (FCPP) according to another embodiment;

FIG. 17 is an image of an ear having a hearing enhancement device having three closely spaced microphones thereon;

FIG. 18 is a graphical representation of signals recorded from two closely spaced microphones;

FIG. 19 is a schematic radiation diagram for two closely spaced microphones oriented in different directions;

FIG. 20 is a schematic diagram of a coherent Independent Components Analysis (cICA) algorithm according to one embodiment;

FIG. 21 is a schematic diagram comparing different generalized Gaussian probability distributions for a copula ICA experiment according to one embodiment;

FIG. 22 is a schematic radiation diagram showing a directivity pattern for different frequencies of an ear-mounted omni-directional microphone;

FIG. 23 is a schematic diagram showing a basic cICA algorithm diverging for an artificially distorted directivity pattern;

FIG. 24 is a schematic diagram showing a frequency-domain implementation of a cICA algorithm to inhibit divergence where there is a significant change in directivity with frequency; and

FIG. 25 is a schematic representation of an apparatus for binaural hearing enhancement according to one embodiment.

### DETAILED DESCRIPTION

### I. Computational Auditory Scene Analysis

As discussed above, in spite of the signal processing difficulties involved, the human auditory system is able to handle the problem of auditory source separation very effectively. As a result, the inventors have determined that biological systems may be useful as a guide to assist in solving the problems related to auditory source separation on a computational level.

As used herein, the term ‘auditory scene analysis’ (ASA) refers to extracting information from signal cues available to an auditory system, while the term ‘computational auditory scene analysis’ (CASA) refers to computer-based algorithms for ASA.

It is desirable that any computational system or method that can extract all or most of the information that the human auditory system extracts should be able to perform grouping of auditory streams. From an implementational point of view this may also be important given that neural network type processing architectures may not be suitable for all application platforms. In such a case, the trade-off between performance and feasibility should also be given special attention.

Many real applications of CASA (e.g. hearing aid systems) cannot rely on the kind of computational resources available on a standard desktop or laptop computer (such as fast processors and large memory resources) but are limited to what can be comfortable worn by a user. Most real CASA applications are also more useful if they function in real-time. Accordingly, the types of possible solutions tend to be more severely constrained.

In addition to improving speech intelligibility in noise, such CASA systems should strive to meet at least some of the following requirements:

1) Require limited physical or computational resources. Even in the most generous designs, there are normally far fewer resources available in practical embodiments of CASA systems (e.g. hearing aid devices) than are available on conventional personal computers;

2) Operate in real time. Significant processing delays are generally undesirable in practical embodiments as they can lead to an unpleasant user experience;

3) Minimal distortion. The outputs should not be significantly distorted. Where possible, processing artifacts such as “musical noise” should be largely eliminated in order for processed speech to sound natural;

4) Highly adaptable. Practical systems should be able to operate in a wide variety of acoustic environments with essentially no previous training;

5) Highly responsive. Owing to the time-varying nature of the auditory source separation problem, environmental adaptation by the CASA system should be performed quickly;

One approach to CASA systems is to use a so-called “ideal binary mask” approach, which has proven to be a promising avenue of research for practical systems. One goal of this form of CASA is to use grouping procedures to approximate an “ideal binary mask” by performing a time-frequency decomposition, in which: (i) the time-frequency segments containing signal energy are retained, and (ii) the time-frequency segments containing energy from the interfering sources are discarded.

For example, one definition of an ideal binary mask is provided in Equation 1:

$$m ( t , f ) = \{ \begin{matrix}1 & if s ( t , f ) - n ( t , f ) > θ \\ 0 & otherwise\end{matrix} \qquad ( 1 )$$

where s(t,f) denotes the energy in the time-frequency segment that is attributable to the target, and n(t,f) denotes the energy in the time-frequency segment that is attributable to noise. This approach can effectively separate the target from interference, resulting in substantial gains in intelligibility.

However, the “ideal binary mask” approach tends to be limited in a practical sense since neither the target nor the interference signals are known a priori. Instead, they will normally be estimated via grouping auditory cues.

This limitation tends to result in a suboptimal mask, and care should be taken with the “ideal binary mask” estimation in order to ensure both an adequate level of interference rejection and to inhibit an unacceptable level of distortion in the target signal.

### Cue Estimation

In CASA systems, four principal auditory cues used for auditory grouping that have been identified as being useful: 1) pitch, 2) interaural time differences (ITD), 3) interaural intensity differences (IID), and 4) sound onset times.

1) Pitch

For CASA systems, the fundamental frequency or “pitch” of an auditory signal is useful because it is an important grouping cue. Generally, auditory streams with the same or similar pitch are likely to be from the same source, and thus are good candidates to be grouped together. However, this grouping assumes that the pitch can be reliably estimated, even in noisy and reverberant environments.

While the problem of detecting and estimating pitch in quiet and non-reverberant environments has been investigated, the problem of performing such estimation in more challenging environments (e.g. highly reverberant environments) has not been well explored.

According to one approach aimed at solving this problem, the pitch may be estimated using two slightly different methods depending on the centre-frequency of the band of interest. For example, if a low frequency band is being explored, an autocorrelation function may be used as shown in Equation 2:

$$ACF ( c , j , τ ) = \frac{{\sum }_{n = - N / 2}^{N / 2} r ( c , j + n ) r ( c , j + n + τ )}{\sqrt{{\sum }_{n = - N / 2}^{N / 2} r ( c , j + n )} \sqrt{{\sum }_{n = - N / 2}^{N / 2} {r}^{2} ( c + j + n + τ )}} \qquad ( 2 )$$

Where r(.) represents the sub band signal of interest, c is the channel, j is the time step, and τ is the time lag of the autocorrelation function.

For a given time-frequency unit r(c,j), the first peak not located at the τ=0 position should, under ideal conditions, indicate the pitch period of the designated channel.

For high frequency signals, a similar method may be used, except that the sub band signals r(c,j) are replaced by their envelopes in order to avoid problems associated with unresolved harmonics. In many applications, the overall signal pitch can then be estimated via the summary autocorrelation function (SACF) shown in Equation 3:

$$SACF ( j , τ ) = {\sum }_{c = 1}^{M} A ( c , j , τ ) \qquad ( 3 )$$

where the overall pitch period can then be estimated by finding the time lag associated with the largest peak of SACF(j,τ).

However, this approach may not be completely desirable, as it tends to ignore several significant aspects of how the pitch signal behaves in reality and how it is represented in the time-frequency plane.

In particular, the following facts pertaining to voiced speech and the autocorrelation method should be considered:

1) Even in an acoustically clean environment, the pitch signal may not be present in all sub-bands. For example, in noisy environments, some bands will be dominated by different pitch signals or have no discernible pitch. Such bands should be eliminated prior to performing the summary autocorrelation function, otherwise they may reduce the quality of the estimate.

2) For many parts of speech, the pitch signal may vary more or less continuously over time. Information gleaned from this trajectory can aid in correctly discriminating between the target and interferer and may also aid in grouping time-frequency segments.

3) While pitch may be computed monaurally, it can also provide binaural information. Specifically, the target pitch may dominate the time frequency unit from one ear, but not from the other ear.

4) While the autocorrelation method may be easy to compute, it is subject to half-pitch and double pitch errors. That is, the estimated pitch may occasionally be either half of, or double, the correct pitch value.

5) The pitch period of rapidly changing pitches may be difficult to estimate correctly, if not impossible, in the presence of reverberation. Accordingly, alternative processing schemes may be required in such cases.

6) If the pitch is not changing rapidly, then the autocorrelation functions can produce a pitch estimate that is robust to both noise and reverberation. For example, Table 1 below shows the change in correct pitch estimate with changing Signal to Interference Ratio (SIR) for three voiced interfering signals (for both the left and right ears), in both light and heavy reverberation environments (where “TF units” refers to time frequency units).

TABLE 1

| SIR (Light | # of TF units | SIR (Heavy | # of TF units |
|---|---|---|---|
| Reverberation) | at +/−5 lags | Reverberation) | at +/−5 lags |
| ∞ | 20/25 | ∞ | 22/21 |
| 20 | 21/25 | 20 | 20/19 |
| 15 | 20/23 | 15 | 18/18 |
| 10 | 18/20 | 10 | 17/18 |
| 5 | 14/18 | 5 | 13/16 |
| 0 | 6/15 | 0 | 7/12 |
| −∞ | 0/0 | −∞ | 1/0 |

In some embodiments, instead of using the basic summary auto-correlation function (SACF) discussed above, a “skeleton” auto-correlation function may be used in which in the time-delay corresponding to peak-value of the channel's auto-correlation function is used as the centre for some radially-symmetric function. This results in the modified SACF shown in Equation 3a:

$$SACF ( j , τ ) = {\sum }_{c = 1}^{M} φ ( {argmax}_{τ} A ( c , j , τ ) , τ ) \qquad ( 3 a )$$

where φ is the radial function. One version of this approach for the purposes of source azimuth estimation uses a Gaussian function. However, computational limitations may render such a choice undesirable. Instead, a simple piece-wise continuous function with finite support can produce comparable results.

In spite of these potential problems, pitch remains one of the most significant cues available in hearing systems. In humans auditory systems, pitch seems to be the dominant listening cue in noisy environments, and on a computational level tends to be more robust than other cues. Therefore, from a design perspective, it may be desirable that practical CASA systems consider pitch to be a “robust cue” and incorporate pitch as a primary cue (or at least as a cue of elevated importance), while other cues are used in a supplementary or secondary role, aiding the segregation decision.

2. Interaural Time Difference (ITD)

The interaural time delay or interaural time difference (ITD) is another useful auditory cue. ITD generally operates well on low frequency signals (e.g. below approximately 2 kHz) where the wavelength of the received signals is long enough so that phase differences between the received signals at each ear can be measured generally without ambiguities.

However, at higher frequencies (e.g. above 2 kHz), the ITD of the signal envelopes may be calculated, corresponding to psychoacoustic evidence.

For the purposes of computational systems, the ITD may be computed using some type of cross-correlation for the left and right channels, for example as shown below in Equation 4:

$$CCF ( c , j , τ ) = \frac{{\sum }_{n = 0}^{K - 1} {r}_{r} ( c , j + n ) {r}_{l} ( c , j + n + τ )}{\sqrt{{\sum }_{n = 0}^{K - 1} {r}_{r}^{2} ( c , j + n )} \sqrt{{\sum }_{n = 0}^{K - 1} {r}_{l}^{2} ( c + j + n + τ )}} \qquad ( 4 )$$

An overall ITD map may be computed by calculating the summary cross-correlation function in a similar fashion as done above using Equation 3. This may be a convenient form for some computational systems, since it can be readily calculated. However, it may not be ideal in all systems due to the poor temporal resolution provided by using Equation 4 (which is generally well below the resolution possible in human auditory systems).

Another drawback of using the ITD as a cue is that the ITD is generally not robust to noise and reverberation. For example, in noisy environments, the information gleaned using ITD can be highly misleading. As a result, the human auditory system generally does not use ITD as a significant cue in noisy environments.

For example, the decay in reliability of the ITD cue according to the noise and reverberation levels can be plotted. Table 2 below shows the change in ITD reliability versus SIR in different acoustic environments, with a target signal present at an azimuth of 0°, and three interfering signals present at 67°, 135°, and 270°. For a single time period, Table 2 counts the number of frequency bins (out of a possible 32) where the target direction is correctly guessed to within +/−4 time lags. It is notable that there is a high level of TF units indicating a target at 0° when no such target is actually present.

TABLE 2

| SIR (Light | # of TF units | SIR (Heavy | # of TF units |
|---|---|---|---|
| Reverberation) | at 0° | Reverberation) | at 0° |
| ∞ | 24 | ∞ | 16 |
| 20 | 22 | 20 | 18 |
| 15 | 20 | 15 | 17 |
| 10 | 12 | 10 | 16 |
| 5 | 10 | 5 | 15 |
| 0 | 8 | 0 | 11 |
| −∞ | 5 | −∞ | 8 |

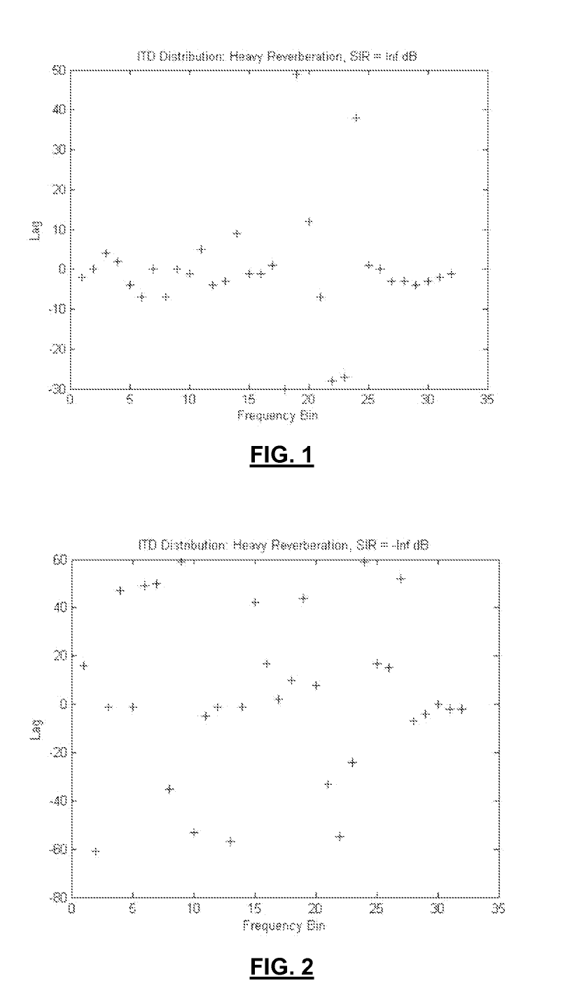

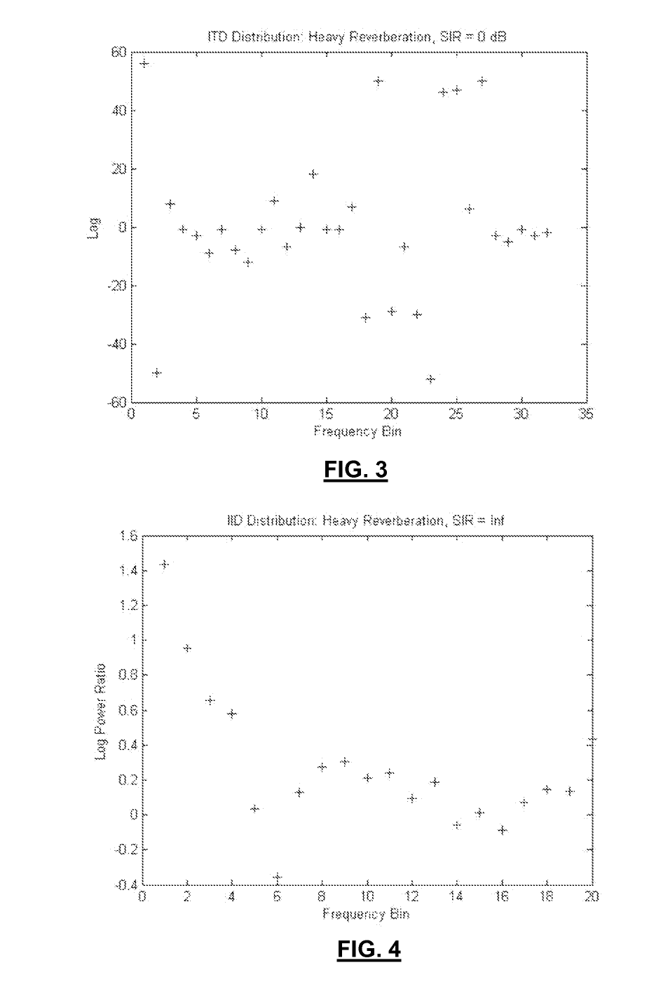

Furthermore, as shown in FIGS. 1, 2 and 3, the presence of interfering signals results may result in significant variability in the observed lag.

It appears evident that the reliability of the ITD measurement is highly dependent on the environment. Indeed, in some cases, it is difficult to even determine whether or not the ITD measurement is able to distinguish the existence of a real target.

Accordingly, any practical CASA system making use of ITD as a cue should allow for a measure of adaptation to the environment in order to reflect a decrease in confidence in the ITD cues.

3. Interaural Intensity Difference (IID)

Interaural intensity different or interaural level difference (IID) is another useful auditory cue, and like ITD is generally easy to compute. For example, the IID cue can be computed by taking the log of the power ratio between the right and left channels, as shown in Equation 5:

$$IID ( c , m ) = log \frac{{\sum }_{t} {{r}_{c , m} ( t )}^{2}}{{\sum }_{t} {{r}_{c , m} ( t )}^{2}} \qquad ( 5 )$$

However, The information obtained from IID is generally only considered valid for frequencies greater than about 800 Hz. As with the use of ITD, some care should be used when interpreting IID cues and how they relate to the grouping of auditory streams. In particular, due to the presence of noise and reverberation, there is generally no simple mapping that can associate an IID value with a source from a particular azimuth.

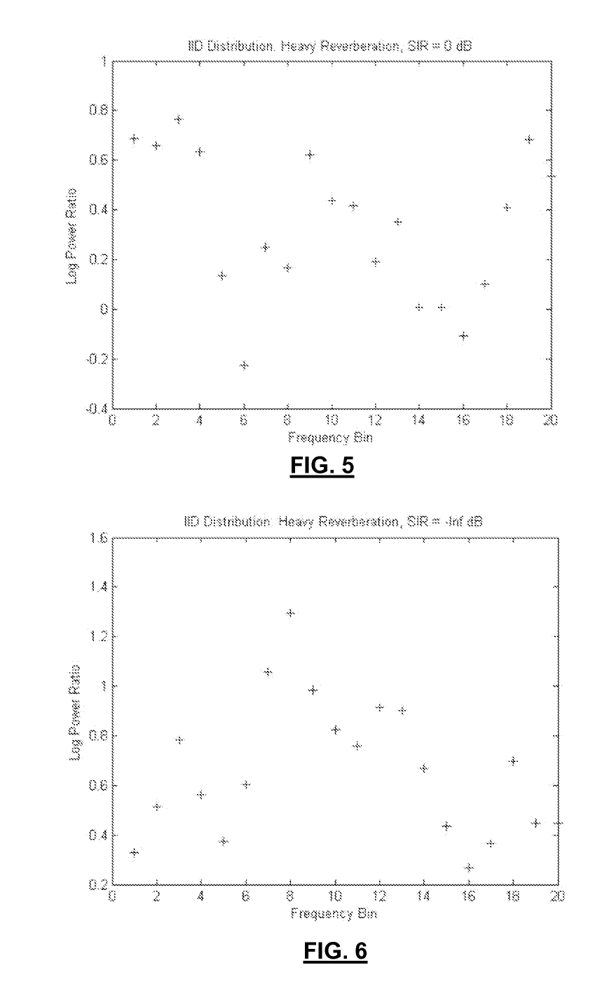

For example, FIGS. 4 to 6 show the kind of variation that may result when using IID cues. At present, the nature of this variation has not been well accounted for. Accordingly, practical CASA systems making use of IID cues should take these limitations into account.

4. Onset

Acoustic onset is another useful auditory cue. One benefit of the onset cue is that it aids the grouping of time-frequency units in time as well as in frequency. In other words, units that have the same onset are likely to belong to the same stream or group.

Furthermore, the directional cues immediately following an onset cue are largely unaffected by reverberation, and thus tend to be more reliable than at other times.

According to some embodiments, the detection of onset times may be done by measuring a sudden increase in signal energy across multiple frequency bands. However, this is not necessarily the preferred approach in every case since these techniques may require additional filtering steps or complicated thresholding procedures.

A more efficient and perhaps more reliable way to make use of acoustic onsets is suggested by the variance of the ITD and IID discussed above. Specifically, the lack of reverberation that accompanies acoustic onset tends to ensure that the variance of the ITD and IID cues drops markedly following the point of onset. The also tends to be true of channel-wise cross correlation coefficients as well.

This observation may be exploited to determine acoustic onset. For example, acoustic onset may be determined by computing the change in channel power over successive frames, and which is then compared to a pre-chosen threshold. For the ith channel and the kth frame, the decision function is shown as Equation 6:

Oᵢ=xᵢ(k)>θ·xᵢ(k−T) (6)

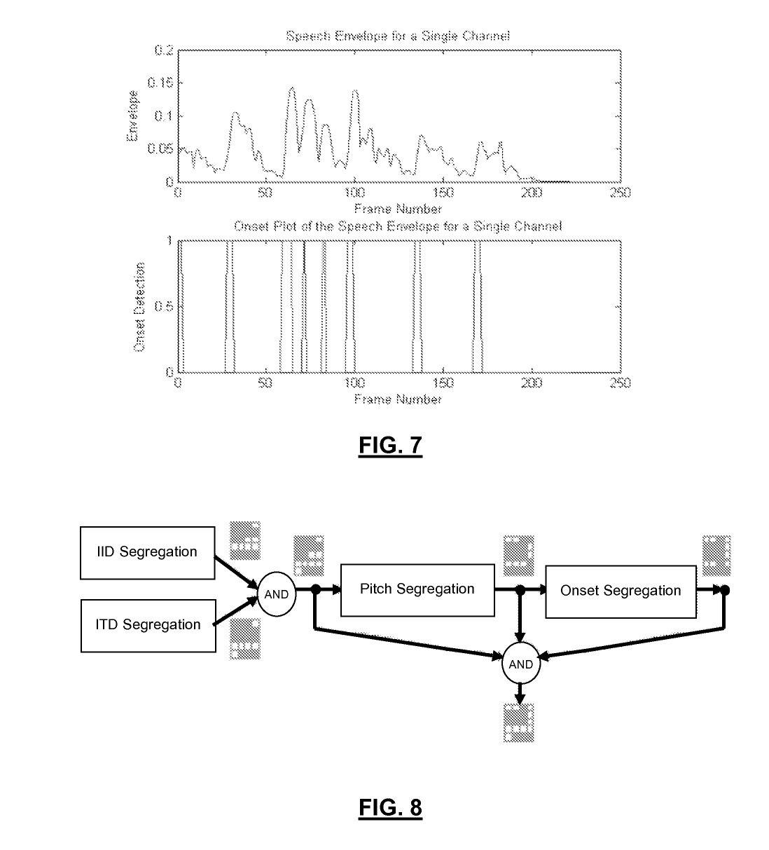

which assigns a value of 1 if the relation is true, and 0 if it is false. For example, FIG. 7 shows the speech envelope for a single frequency channel and the estimated onset periods for that channel calculated using Equation 6.

Unfortunately, under realistic acoustic conditions, the timing and/or existence of a clearly defined onset can be quite variable, so an estimator like Equation 6 may not be wholly reliable. For this reason, in some embodiments the onsets may be summed across frequency channels.

In addition, the binary truth value of the acoustic onset may carried over to the next frame. For example, if an onset was detected in the previous frame, then the current frame may also be registered as an onset frame regardless of whether the condition in Equation 6 was satisfied. This approach may be desirable due to the fact that onset periods in the speech envelope occur over multiple frames, and an extra degree of robustness may be advantageous under adverse conditions.

### II. System Configuration

As described above, the human auditory system is able to perform remarkable feats using two ears. Even allowing for the tremendous processing power of the brain, this still means that all of relevant information is accessible with only a single pair of inputs.

Even if the full range of human capabilities cannot realistically be replicated in practical CASA systems, the inventors still believe that only a minimal number of sensors may be required to generate satisfactory results, thus relieving the burden of managing a large number of input streams. For example, such problems may arise in the use of spatial processing strategies based on beamforming.

Such systems can exploit the information available in the auditory inputs stream using only a minimal number of sensors. For example, a binaural configuration may used to extract both the directional and monaural cues, which can be subsequently combined in a later stage of processing.

However, such a system may not be wholly adequate, as the directional cues tend to be symmetric with respect to front and back. Accordingly, any interferers behind the listener may be incorrectly identified as belonging to the target source, which will further add to the interference.

In human auditory systems, this problem tends to be resolved by the outer ear, or “pinna”, which uses a combination of improved directionality and directional spectral shaping to resolve the problem of front-back confusion.

However, the operation of the pinna is not well understood, and tends to be highly individualized. Therefore, a pinna structure that works well for one person may not necessarily work or improve the situation for another person.

Therefore, according to some embodiments, a second set of rearward-facing microphones can be added to the system. These rearward-facing microphone provide a means of measuring the interference emanating from behind the user. In other words, these microphones fill the role of the “noise reference” microphone in other noise control applications.

The outputs of these rearward facing microphones can then be incorporated into a spectral subtraction algorithm as described in greater detail below.

In some embodiments, the rearward-facing microphones may be directional in nature. For example, in some embodiments the rearward-facing microphones may have a directional gain greater than 3 dB. In other embodiments, rearward-facing microphones with directional gain of as little as 2.5-3 dB may be used, and may provide a sufficient reduction in interference.

### III. Cue Fusion with Fuzzy Logic

One implementation of a CASA system was described in Dong, Rong, Perceptual Binaural Speech Enhancement in Noisy Environments, M.A.Sc thesis, McMaster University, 2004, and which was described as a ‘cocktail party processor’ (CPP).

The inventors believe that the CPP was generally capable of suppressing interference to a large degree under certain source-receiver configurations. For example, one embodiment of the CPP was a sequence of binary AND operations that assigned a logical ‘1’ to those time-frequency windows that fell within the target range for a specific cue, and ‘0’ otherwise (as shown for example in FIG. 8).

However, the inventors have discovered that the CPP tends to suffer from annoying musical noise artifacts that reduced the perceptual quality of the signal. In particular, in the CPP system, each cue is as important as any other, and there is no differentiation between the auditory roles of different cues. Additionally, each channel is considered separately, so there is no true grouping based on a hierarchy of cues. These problems tends to become more pronounced in very noisy environments, and where the level of reverberation is also increased.

One proposed improvement to the CPP system involves changing the logical AND operations to real-valued multiplications, while leaving the rest of the processor essentially unchanged. However, this approach tends to mitigate the problem of processing artifacts, but does not substantially eliminate it.

### A New Approach to Cue Fusion

Accordingly, the inventors now believe that the problem may be defined, not as how to estimate the cues needed for grouping, but rather how to make use of the cues in order to estimate the target speech signal while meeting the desired standard of quality.

This is not a straightforward problem, particularly given that the information needed for such estimations is often of uncertain quality, and usually time-varying as well. In fact the statistical distributions that determine how much confidence one can have in the measured cues also tend to be time-varying and difficult or impossible to know.

However, as discussed above, the inventors have observed that the estimation of pitch tends to more robust to the effects of noise and reverberation as compared to other cues. In particular, pitch estimation tends to be robust to reverberation (provided that the pitch changes slowly enough).

Furthermore, for onset periods within the speech envelope, the localization cues tend to remain robust in the presence of reverberation.

Accordingly, the inventors have identified new cue fusion methods, apparatus and systems that take into account both: (i) the differing levels of cue robustness, as well as (ii) the inherent uncertainty of cue estimation in real acoustic environments. Specifically, such methods, apparatus and systems make use of the observations noted above regarding the behavior of these auditory grouping cues, and encompass the following two concepts:

(i) The most acoustically robust cues are more important in terms of grouping (and may be the most important). Less robust cues should be used in a supplementary role to constrain the association of the more robust or primary cues.

(ii) The variability of the cue distribution suggests that the interpretation of the cues should be in terms of the mean and variance over several channels, and not in terms of any individual time-frequency units.

Cue Robustness

The first concept of placing more emphasis on the most reliable cues is fairly straightforward. For example, as discussed above, both pitch and onset are robust cues that may be considered as primary or “robust” cues.

However, for both pitch and onset, there can be significant ambiguity as to how to segregate auditory streams into target and interference signals. For example, at a given instant it is possible that the dominant pitch will be from an interfering signal rather than the target.

Generally, neither the pitch nor the onset can by themselves resolve the problem of stream identity, as they are both monaural cues and are ambiguous with respect to direction. Accordingly, additional cues should be used to constrain the identity of the stream.

Therefore, according to some embodiments, the grouping can be done as a two-stage process, wherein:

(i) the initial groupings is made using the robust or primary cues (e.g. onset and/or pitch), while

(ii) the specific identification of groupings is made using the less reliable or weaker directional cues (e.g. IID and/or ITD).

Variability of Cue Distribution

Use of the weaker cues triggers a consideration of the second concept, namely how to use uncertain cues to produce an accurate estimate of the target signal.

For example, supplementary to the robust cues (e.g. pitch and onset) the secondary or weaker cues (e.g. ITD and IID) display much greater vulnerability to noise and reverberation.

According to some embodiments, the use of these weaker cues entails determining the distribution of spatial cues within each previously segregated stream.

For example, in one embodiment, for a voiced segment, it is possible to determine the average ITD and IID of all time-frequency units corresponding to that specific periodicity. Then, a determination can be made whether or not the average is sufficiently close enough to the required target location. If the average is sufficiently close to the required target location, then the corresponding TF units may be determined to be from the target and retained.

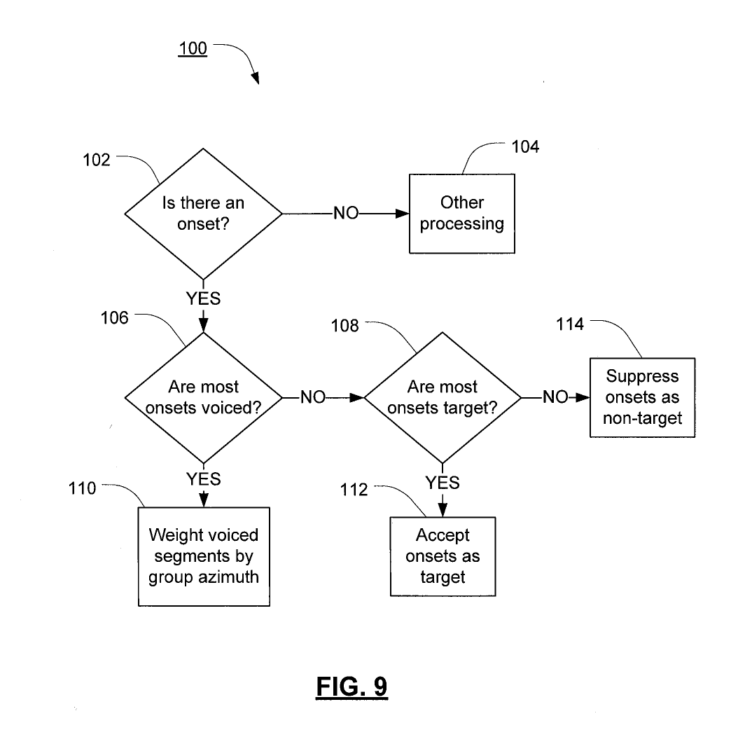

In some embodiments, it may also be possible to further refine the mask estimate by discarding those grouped TF units that deviate too far from the mean. For example, a method 100 of processing steps for input envelopes exhibiting an onset period is shown in FIG. 9.

According to the method 100:

At step 102, a determination is made as to whether an onset cue is present. If no onset cue is present, then the method 100 may proceed to step 104, where other processing is performed of the auditory signal (e.g. other cues such as pitch may be analyzed). However, if an onset cue is present, then the method 100 proceeds to step 106.

At step 106, a determination is made as to whether most of the onsets are voiced. If the answer is no (e.g. most of the onsets are not voiced), then the method 100 proceeds to step 108. However, if the answer is yes (e.g. most of the onsets are voiced), then the method 100 proceeds to step 110, where the voiced segments are weighted by group azimuth.

At step 108, a determination is made as to whether most of the onsets are from the target. If the answer is yes, then the method 100 proceeds to step 112, where the onsets are accepted as target. However, if the answer is no, then the method proceeds to step 114 where the onsets are suppressed as non-target.

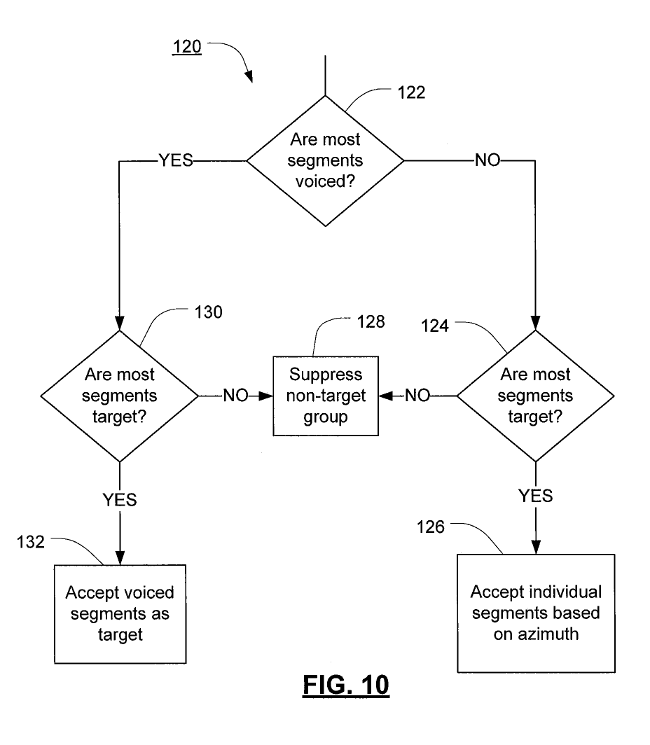

Turning now to FIG. 10, a method 120 for processing for non-onset periods is shown. According to method 120, at step 122, a determination is made as to whether most segments are voiced. If the answer is no then the method 120 proceeds to step 124. Otherwise, if the answer is yes then the method 120 proceeds to step 130.

At step 124, a determination is made as to whether most segments are target. If the answer is yes, then the method 120 proceeds to step 126, where the individual segments are accepted based on the azimuth. Otherwise the method 120 proceeds to step 128, wherein the segments are suppressed as being part of a non-target group.

As described above, if the answer to step 122 is yes, then the method 120 proceeds to step 130. At step 130, a determination is made as to whether most of the segments are target. If the answer is yes, then the method 120 proceeds to step 132 and the voiced segments are accepted as target segments (e.g. the voiced segments are close to the dominant pitch frequency as determined using the SACF). However, if the answer is no then the method 120 proceeds to step 128 where the segments are suppressed as being part of the non-target group.

Formally, this new approach to cue fusion may be described using fuzzy logic techniques. This allows for the expression of membership and fusion rules where the relationships are not clear-cut, and where the amount of information may be inadequate for probabilistic forms of reasoning.

For example, for cue-fusion in CASA systems, one pitch grouping rule can first be expressed linguistically as:
IF most pitch elements are near 0° AND the individual units are near 0°, THEN these elements belong to the target.

The italicized words (e.g. most and near) are linguistic concepts that can be expressed numerically as fuzzy membership functions. These functions may range from [0,1] and may indicate the degree to which the inputs satisfy the linguistic relationships such as most, near and so on.

Numerically, the individual membership functions can be expressed in a number of ways such using a Gaussian functions as in Equation 7:

$$μ ( x ) = {e}^{\frac{- {( c - x )}^{2}}{2 {σ}^{2}}} \qquad ( 7 )$$

or other equations.

Membership rules like Equation 7 may be used to describe the approximate azimuth of the position in terms of ITD and IID, where c describes the centre of the set and a controls the width.

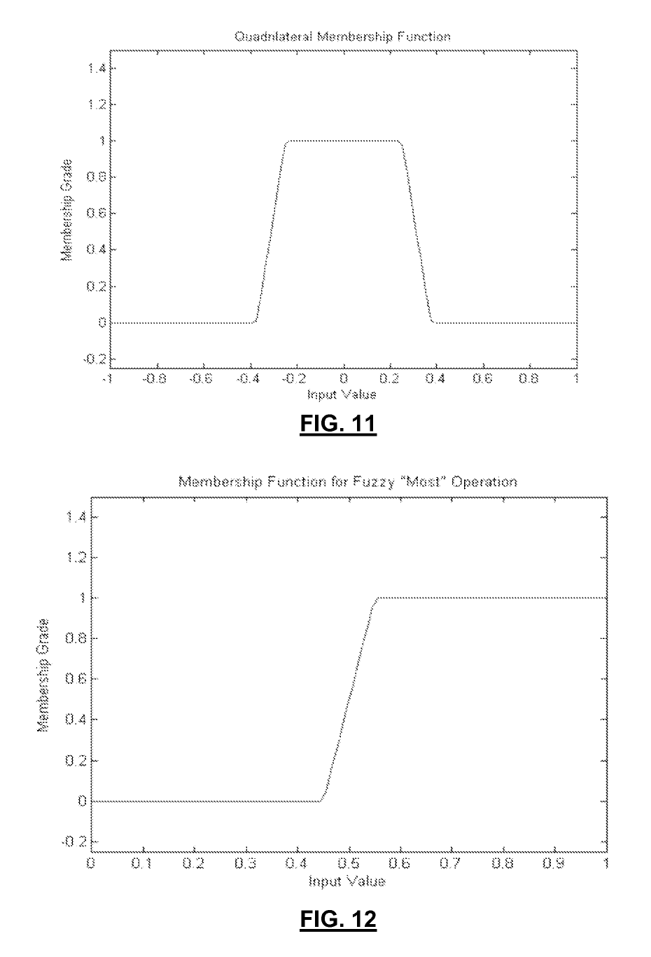

Another useful form of a fuzzy logic membership function may be provided by the quadrilateral function shown in FIG. 11. This function has an advantage over Equation 7 in that it may be simpler to compute, and as a result may be used for all symmetric type membership functions in some embodiments.

The fusion rules themselves may be expressed in terms of the fuzzy logic counterparts of the more conventional binary logic operators such as AND, OR, etc. For example, in fuzzy logic terms, the AND operator used to describe the simple fusion rule above may be expressed as either Equation 8 or Equation 9:

A(x) AND B(y)=min(μ_{A}(x),μ₈(y)) (8)

or

A(x) AND B(y)=μ_{A}(x)·μ_{B}(y) (9)

where μ(.) indicates the membership functions for the respective fuzzy sets.

Experimentation with both types of operators suggests that while Equation 9 generally leads to better interference rejection, its use may lead to greater amounts of musical noise than if some variant of Equation 8 is used.

Onset

For example, according to some embodiments, for an individual frame, the onset cue may be calculated according to Equation 6 as described above. Then, the number of frames exhibiting an onset at that time may then be summed up and subjected to the fuzzy operation:

If many onsets have been detected, THEN “Onsets” is TRUE (10).

In this case, the fuzzy many operation is computed in the same way as the most operation (see FIG. 12), albeit with a lower threshold. The result of Equation 10 may be further refined for unvoiced signals using an additional condition:

If (most ITDs are target OR most IIDs are target) AND the current frame is an onset frame, AND the front-back power ratio is high THEN the current frame is target. (11)

For voiced signals with an onset, the fuzzy condition is similar, except that all frames with the same pitch as onset frames may also be judged to be part of the target stream. Similarly, the onsets cue may also be used to reject onset groups where most members of the group are identified as not being close to the target azimuth.

Pitch

Furthermore, according to some embodiments, the dominant or primary pitch may be determined (e.g. by using Equation 3). Once the dominant pitch has been found, all current frames exhibiting a pitch value may be compared to that dominant or primary pitch.

In the absence of an onset cue, then the fuzzy condition applied may be similar to Equation 11. Specifically, if a dominant pitch is present, the rule may be:

IF most of the pitch ITDs AND most of the pitch IIDs are target THEN the related pitch frames are also target. (12)

For the case when no pitch is present, or where the detected pitch does not belong to the target, the remaining time-frequency frames may be subject to one final rule:

IF most of the ITDs OR IIDs are target AND the current ITD is target AND the current IID is target, THEN the current frame belongs to the target. (13)

As with the onset cue, pitch grouping may also be used to reject larger groups with the same pitch.

### IV. Control

The reliability of the cues that have been discussed above, as well as the reliability of the fusion mechanisms used to extract the target source from the mixture, tend to depend on the acoustic environment in complex ways that are difficult to quantify. In a general sense, it can be said that the quality of the separation that is achievable depends on the signal to noise ratio (SNR).

This quality may also be discussed in two separate ways: (i) the degree of interference suppression, and (ii) the elimination of unpleasant artifacts in the filtered signal.

With increasing noise levels, both measures of quality tend to suffer, and a threshold may be reached, above which not only does the interference suppression fail to improve the quality of the speech, but in fact it may actually reduce the quality of the speech by introducing noticeable artifacts.

As a result of these quality problems, some control mechanism may be useful to regulate to what degree the interference suppression is applied, and even whether it should be applied at all.

One proposed technique is to use an adaptive smoothing parameter as a means of combating musical noise. This involves smoothing the calculated gain coefficients over time, for example in the manner shown in Equation 14:

\hat{ρ}(t,j)=β(t,j)·ρ(t,j)+(1−β(t,j))·\hat{ρ}(t,j−1) (14)

where ρ is the gain calculated by applying the fuzzy fusion conditions, β(j) is a time varying smoothing parameter, and \hat{ρ}(j) is the smoothed gain estimate. The smoothing parameter may be adjusted on the basis of the estimated SNR generally as described above. However, while this approach does tend to reduce musical noise, there still may be significant problems with this form of distortion.

Therefore, according to some embodiments, the single control equation described in Equation 14 has been broken into two separate mechanisms that each address different parts of the suppression/distortion trade-off.

For example, in some embodiments, the smoothing formula of Equation 14 is retained, although with a different purpose. Instead of adapting to the estimated SNR, the smoother adapts to the signal envelope. This may be accomplished by allowing the smoothing parameter to take on only two different values, which result from onset and non-onset periods:

$$β ( t , j ) = \{ \begin{matrix}HIGH & if onset = TRUE \\ LOW & if onset = FALSE\end{matrix} \qquad ( 15 )$$

The change in smoothing parameter may reflect the different degrees of cue reliability in the two components of the envelope.

For example, at the signal onsets, which are generally minimally contaminated by reverberation, the directional cues tend to be at their most reliable, and should be adapted to the quickest.

Conversely, the time periods after the onset tend to have a much greater degree of reverberation present in the signal, which lowers the reliability of the directional cues. However, due to the continuity of the speech envelope, the target time-frequency units are more likely to be in the same frequency band as the onsets, so the adaptation rate should be reduced.

In some embodiments, for this application, values of HIGH=0.3 and LOW=0.1, were found to produce good results.

The second aspect of the control problem performs the original intent of the smoothing term introduced above (e.g. to control the problem of musical noise).

In Equation 14, the intent is to average out the musical noise via smoothing, at the cost of decreased adaptativity as well as a greater amount of interference. The problem of trading-off the adaptation performance of the CPP tends to be addressed by making the smoother adapt to the signal envelope instead of the SNR. The problem of musical noise and similar artifacts can then be addressed, not by smoothing but by selectively adding in the unprocessed background noise. Specifically, the final gain calculation for the controller may be expressed as Equation 16:

g(t,j)=\hat{ρ}(t,j)+ [symbol] \hat{ρ}(t,j)·FLOOR (16)

where g(t,j) is gain for the jth frame, \hat{ρ}(t, j) is the smoothed gain estimate from Equation 14, [symbol] \hat{ρ}(t, j) is its logical complement (e.g. [1−\hat{ρ}(t, j)]), and FLOOR is some pre-defined minimum gain value. Equation 16 in essence tends to work like a fuzzy Sugeno controller since the value \hat{ρ}(t, j) is not merely a gain estimate, but in fact tends to represent the truth-value of the fuzzy conditionals that were described above.

The value of the minimum gain FLOOR may be adaptive and may depend on the estimated signal-to-noise ratio (SNR). For high SNRs, the FLOOR may be set to be low, and may be set to increases with increasing estimated SNR.

It should be stated that reliable estimation of the SNR may be problematic, since the reliability of the estimator is also strongly dependent on the SNR.

In some embodiments a softmask approach to interference suppression may be used and it is not wholly possible to simply group accepted and rejected time-frequency bins. Instead, the division of target and interference power may rest on the degree of confidence with which the fuzzy conditionals accept or reject a given time-frequency bin.

These techniques may calculate the power only where the confidence in the algorithm's acceptance or rejection is high. In other words, the value of \hat{ρ}(t, j) or [symbol] \hat{ρ}(t, j) should be high in order for the bin to be considered for SNR calculations.

Once the bin has been accepted as either target or interference, the SNR may calculated, for example using Equation 17:

$$SNR ( t ) = 10 \cdot {log}_{10} \frac{{\sum }_{j} {‖ {\hat{ρ}}_{s} ( t , j ) ‖}^{2}}{{\sum }_{j} {‖ {\hat{ρ}}_{i} ( t , j ) ‖}^{2}} \qquad ( 17 )$$

In the estimator of Equation 17, \hat{ρ}ₛ(t, j) are the target frames, and [symbol] \hat{ρ}ᵢ(t, j) are the interference frames.

### V. Spectral Subtraction

Unfortunately, the cue estimation and fuzzy logic fusion routines that have been described above tend to be ambiguous with respect to noise sources located behind the listener. In particular, the directional cues that may be used to discriminate between target and interference are generally unable to distinguish between front and back owing to the symmetry of the problem. Therefore, it is desirable that additional techniques be applied to distinguish between front and back sources.

According to some embodiments, this may be accomplished by using at least two (e.g. one pair) of rearward-facing directional microphones and a basic spectral subtraction algorithm. It will be appreciated that in other embodiments, more than two rearward-facing directional microphones may be used (e.g. four rearward-facing directional microphones may be used).

In particular, a simple algorithm was found to produce adequate results. This algorithm simply assumes the signal-to-noise ratio (SNR) is directly calculable from the power ratio of the front and back microphones, and accordingly, the gain for a given time-frequency unit may be calculated as Equation 18:

$$SNR ( t , j ) = \frac{{P}_{front} ( t , j )}{{P}_{back} ( t , j )} \\ {Gain}_{ss} ( t , j ) = \sqrt{\frac{SNR ( t , j )}{1 + SNR ( t , j )}} \qquad ( 18 )$$

where P(t,j) is the power in the frame at time t and frequency bin j for both the forward-facing and rearward-facing microphones.

The resulting gain to be applied is Gainₛₛ(t,j) which may be smoothed over time in the same manner as Equation 14, although generally with a constant rather than variable smoothing factor. According to some embodiments, Equation 18 may be applied as a post filtering procedure as it tends to perform poorly if applied before the initial interference suppression algorithm.

### VI. Summary of Changes to CPP Systems

According to some embodiments, a number of changes may be made to CPP systems to improve performance. In particular:

1) The cues may be grouped according a hierarchy that is based on the robustness of those cues. The identity of the segments that have been grouped may then be constrained based on the average behavior of the less reliable (e.g. weaker) cues.

2) The grouped channels may now be considered as a whole, and not as individual elements.

3) The fact that the directional cues are more robust during onset periods may be incorporated into the design by making the smoothing rate adaptive to the signal envelope.

4) The decision and data fusion rules may be reformulated in terms of fuzzy logic operations. This allows for a change in the nature of the fusion rules, which tends to substantially reduce musical noise.

5) A new SNR adaptive control mechanism may be introduced in order to improve the perceptual performance, particularly in especially difficult environments.

6) The front-back ambiguity present in the original CPP design may be been greatly mitigated via a spectral subtraction block that makes use of two additional rearward facing microphones.

### VII. Exemplary Results

Discussed in some detail below are exemplary results based on a trial of both the original CPP as well as an improved embodiment as generally described herein.

In these examples, there is a male target talker located in front of the listener and three other interfering talkers (two male and one female) located elsewhere in the room. The resulting SNR was equal to 1 dB. This example was set up using the measured impulse responses of a reverberant, hard-walled lecture room.

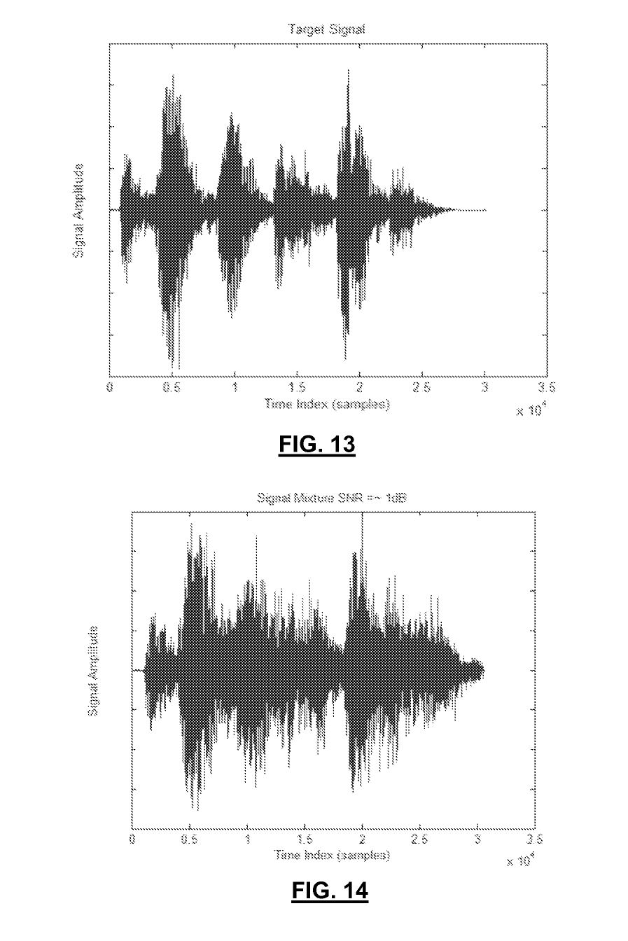

FIG. 13 shows the recording of the original target signal as recorded in the reverberant lecture room.

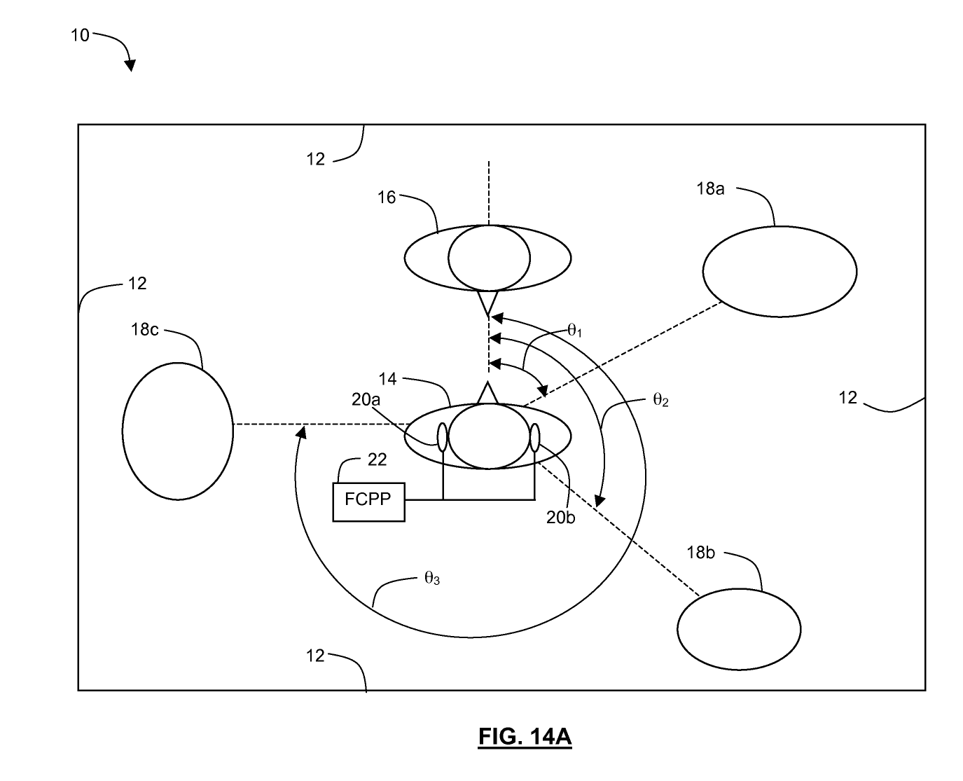

FIG. 14 shows the observed mixture with the three interfering talkers as well as the original target signal.

By inspection and comparison of FIGS. 13 and 14, it is apparent that the original target signal has been subjected to significant interference from the interference signals from the three interfering talkers.

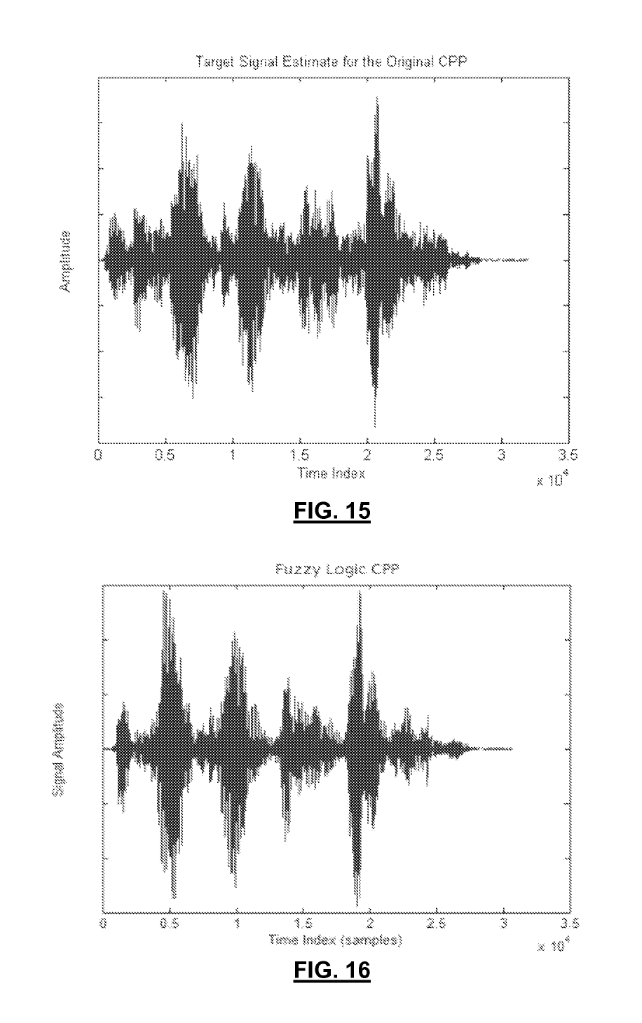

FIG. 15 shows an estimated signal generated using the original CPP system to process the mixture observed in FIG. 14. By inspection and comparison of FIGS. 13 and 15, it is apparent that the original CPP system has removed some, but not all, of the interference signals caused by the three talkers.

FIG. 16, on the other hand, shows an estimated signal generated using a Fuzzy CPP (FCPP) system according to one embodiment that incorporates techniques described herein.

For example, one embodiment of a FCPP system is shown in FIG. 14A. In this Figure, the reverberant environment is a room 10 with a plurality of walls 12. A listener or observer 14 is positioned somewhere in the room 10 and is listening to target speech (e.g. the “target signal”) from a speaker 16 nearby. As shown, the listener 14 and speaker 16 are directly across from each other and are facing each other (as shown).

Also in the room are three interference sources 18a, 18b and 18c (e.g. interfering talkers). As shown, the first interfering talker 18a is positioned at a first angle θ₁ with respect to the line between the listener 14 and the speaker 16, the second interfering talker 18b is positioned at a second angle θ₂, and the third interfering talker 18c is positioned at a third angle θ₃. In the embodiment shown, the first angle θ₁ may be approximately 67°, the second angle θ₂ may be approximately 135° and the third angle θ₃ may be approximately 270°.

The listener 14 generally has two ears, a left ear 20a and a right ear 20b, each coupled to a FCPP system 22. As generally described herein, the FCPP system 22 assists the listener 14 in understanding the target signal generated by the speaker 16 by extracting the target signal (from the speaker 16) from an auditory signal that includes the target signal and interference signals (e.g. from the interfering talkers 18a, 18b, 18c).

As evident by inspection and comparison of FIGS. 13, 15 and 16, the FCPP system 22 has reduced the level of background noise (e.g. interference) as compared to the original CPP system. Table 3 further highlights the SNR improvements.

TABLE 3
Table of SNR improvements.

| Input SNR | SNR Improvement over CPP |
|---|---|
| 1.0 dB | 4.46 dB |
| 2.0 dB | 4.12 dB |

FIGS. 13 to 16 show that the output of the signal estimates generated using the FCPP embodiments described herein more closely approximates the original target signal.

In particular, it is clear that there is less interference in the estimate illustrated in FIG. 16 as compare to FIG. 15.

Audible musical noise is also greatly reduced using the FCPP system 22, which substantially improves the comfort level of user.

### Testing and Metrics

It is beneficial if the performance of the FCPP can be quantified in order to determine how well it improves both speech intelligibility and quality. Unfortunately, such quantification is not a wholly straightforward task. In particular, there is a significant lack of useful and objective speech quality metrics.

For example, one commonly used measurement is SNR. However, generally this does not take into account the perceptual significance of any distortions in the raw signal. Therefore, it is difficult or even impossible to know whether or not a particular deviation is perceptually annoying to (or even whether it is even noticed by) a user.

This of particular importance where there are many short-term changes in the signal across different frequency bands that make a simple subtractive metric like the SNR difficult to apply.

There are several possible solutions as to how this problem may be addressed. One approach is to examine modified versions of the SNR that are better able to take into account the perceptual quality of speech. Another approach is to use the Articulation Index (AI), which is an average of the SNR across frequency bands, or the Speech Transmission Index (STI), where weighted average of SNRs are computed. The weights in the STI formula may be fixed in accordance with the known perceptual significance of the sub-bands.

In some embodiments, the band-averaged SNR is used, in which the quality measure is an average of the signal-to-noise ratios of each individual frequency band m=1 . . . M. This quantity is in turn averaged over all time windows n=1 . . . N for the segment in question, resulting in the following measure as shown in Equation 18a:

$$SNR = \frac{1}{MN} {\sum }_{m = 1}^{M} {\sum }_{n = 1}^{N} {SNR}_{nm} \qquad ( 18 a )$$

The use of this measure has the benefit of simplicity as it is easy to compute as well as being intuitively clear in its meaning. In addition, the use of a uniform weighting in the averaging scheme of Equation 19a tends to ensure that the quality measure is not tied to any one signal model.

### Coherent ICA

The Limitations of CASA

While in some embodiments, the FCPP works very well, improving the performance is still desirable. For example, the performance of the FCPP tends to decline significantly in multitalker environments when the SNR goes below a range of around −1 to 0 dB. In such environments, there tends to be more uncertainty in the identification of the target vs. the interferer, and it is more likely that the dominant signal will not be the desired target.

Therefore, one desirable goal would be to eliminate as much of the interference from the received auditory signals as possible before feeding the received auditory signals into the CASA processor. This may increase the quality of the output sound by both reducing some of the actual interference, as well as improving the reliability of the cue estimates. Thus, the over-all effect tends to improve the quality of the resulting time-frequency mask.

Instead of using CASA techniques, such an auditory signal pre-processor could be based on more traditional signal-processing methods that complement the kind of processing used in CASA. However, certain design limitations should be kept in mind. In particular, the pre-processor should generally function under the constraints of real-time processing, limited computational resources, and the need for a small, wearable device that can process sound binaurally.

Independent Components Analysis

One general approach to blind source separation through independent components analysis (ICA) involves estimating N unknown independent source signals s(t) from a mixture of M recorded signals x(t). In the basic formulation of ICA it may be assumed that the received mixtures are instantaneous linear combinations of the source signals as is shown in Equation 19:

x(t)=As(t)+v(t) (19)

where A is an unknown M×N mixing matrix. The goal of ICA is to find a de-mixing matrix W such that that

\hat{s}(t)=Wx(t) (20)

is the vector of recovered sources.

In many or most real-world acoustic applications, this model tends to be inadequate, since it takes neither time-delays due microphone spacing nor the effects of room reverberation into account. Instead of the simple linear mixture of Equation 19, the received mixtures are in fact a sum of reflected and time-delayed versions of the original signals, a situation that is much harder to model. Algorithms based on the linear mixing model of Equation 19 therefore tend to be generally inadequate for such general problems.

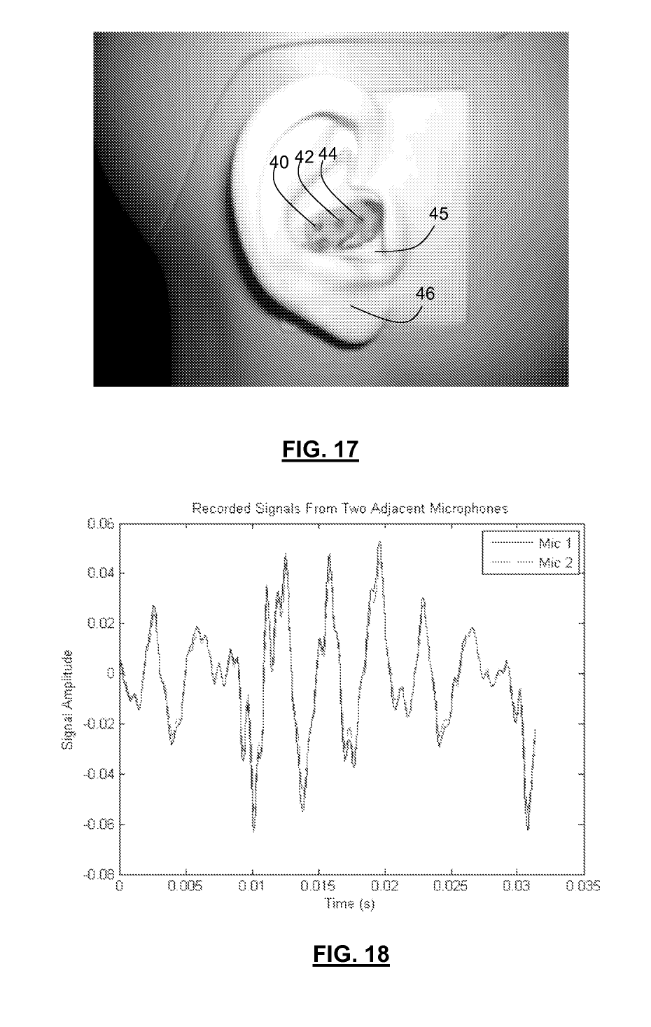

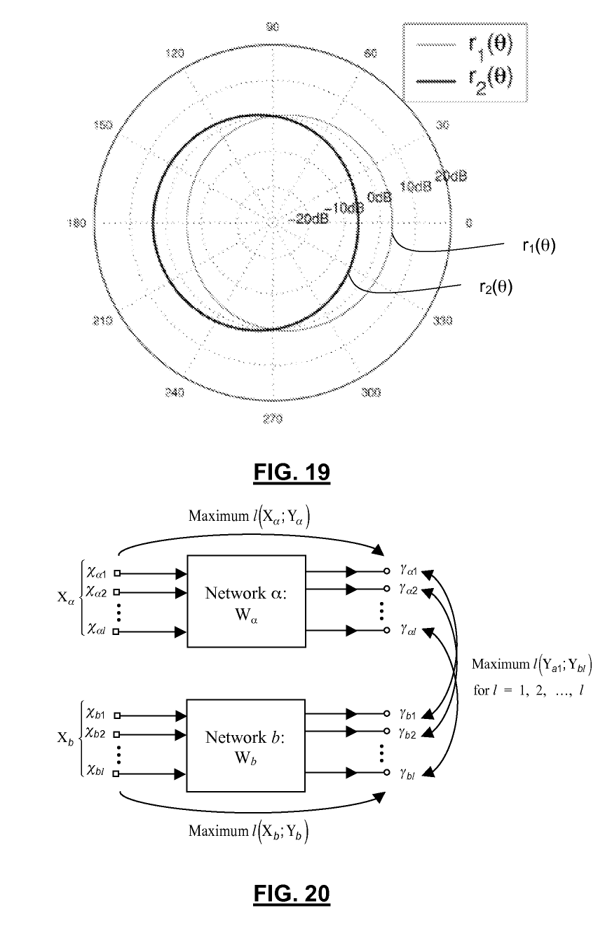

However, if the microphone spacing is small enough, then the problem of convolutive mixing tends disappears. For example, in one experiment three closely spaced in-the-ear microphones were used to record data as part of the R-HINT-E project. The arrangement of the microphones is shown in FIG. 17, with a first microphone 40, a second microphone 42, and a third microphone 44 provided in the opening 45 of an ear 46.

Sample recordings taken by two of these adjacent microphones (e.g. the first microphone 40 and the second microphone 42) are shown in FIG. 18. It is apparent by inspection that the signal differences between the microphones are relatively minor, and there is no meaningful time-delay between them. Note that the room impulse responses used for this recording were from a hard-walled reverberant lecture room.

Accordingly, using ear-mounted directional microphones that are closely spaced together, it may be possible to solve the ICA problem using only the linear model of Equation 19. Since each ear would normally possess the same dual microphone arrangement, the binaural signals needed by the CASA system would be available for processing by that unit in the form of outputs from the pre-processor. For this system, it may not be necessary for the ICA algorithm to provide full separation, and all that may be required in some embodiments is at least some removal of unwanted interference.

It will be appreciated that while, in this embodiment, the microphones (40, 42, 44) are shown provided within the ear (e.g. a cochlear configuration), this is not essential, and other configurations are specifically contemplated.

In some embodiments, if the ICA algorithms for each ear are allowed to adapt independently of each other, local variations in signal intensity between the left and right sensor groups may lead to some disparity in the estimated source signals. Furthermore, given the ambiguities of ICA with respect to both magnitude and permutation, the sensors on each ear may extract the desired signal at different strengths, or even with different output signals.

Accordingly, it is desirable that some additional constraints be added in order to help ensure that both of the signals estimated by the ICA pre-processor are the desired target signals, and that the outputs do not confuse the CASA algorithm by distorting the acoustic cues.

Coherent Independent Components Analysis

In the scenario described above, the unconstrained adaptation of the demixing filters for each ear is generally undesirable. However, there is generally no constraint that can prevent undesirable differences between the left and right microphone groups if the filters for each ear are allowed to adapt independently of each other. To inhibit this, any adaptation algorithm should be binaural in nature, allowing the left and right sensors to communicate in some way, so that the two groups of filters converge to a common solution.

This kind of problem has been explored in the context of sensory processing in neural networks, and has been termed coherent ICA (cICA). The purpose of the algorithm was to perform signal separation on two differently mixed (but related) sets of data, such as might occur in the human auditory system. The transformed outputs from each network are normally required to be maximally statistically independent of each other, while at the same time the mutual information between the outputs of the two different networks should also be maximized, for example as shown generally in FIG. 20.

Mathematically, this results in the cost function shown in equation 21:

$${J}_{cICA} = I ( {x}_{a} , {y}_{a} ) + I ( {x}_{b} , {y}_{b} ) + {\sum }_{i} {λ}_{i} I ( {y}_{ai} , {y}_{bi} ) \qquad ( 21 )$$

which is to be maximized over the network weights Wa and Wb. The summation is carried out across all of the elements of each output vector, and the parameter λᵢ is meant to weight the relative importance of signal separation within the individual networks versus the coherence across the two sets of outputs.

Using the mathematical copula in conjunction with Sklar's theorem, a mathematically elegant solution to the problem may be developed that also allows for a considerable increase in computational efficiency. Working from the assumption that the approximate statistical distribution of the signals is known, the work proceeded as follows. Using the definition of the mutual information in conjunction with Sklar's theorem and a coherence parameter of λᵢ=1, the cost function of Equation 21 may be rewritten as Equation 22:

$$\begin{matrix}{J}_{cICA} = {\sum }_{i} E [ log {\hat{p}}_{{Y}_{ai}} ( {y}_{ai} ) ] + {\sum }_{i} E [ log {\hat{p}}_{{Y}_{bi}} ( {y}_{bi} ) ] + \\ {\sum }_{i} E [ log c ( {u}_{ai} , {u}_{bi} ) ] \\ = {\sum }_{i} E [ log {\hat{p}}_{{Y}_{ai}} ( {y}_{ai} ) {\hat{p}}_{{Y}_{bi}} ( {y}_{bi} ) c ( {u}_{ai} , {u}_{bi} ) ] \\ = {\sum }_{i} E [ log {\hat{p}}_{{Y}_{ai} {Y}_{bi}} ( {y}_{ai} {y}_{bi} ) ]\end{matrix} \qquad ( 22 )$$

where the function c(.) is the copula for the model distributions \hat{p}(.) of the random variables yₐᵢ and y_{bi}.

In some embodiments, a generalized Gaussian distribution may be used to demonstrate how cICA could reduce the blind source separation problem to a simple algorithm. The generalized Gaussian distribution may be chosen because of its broad applicability to a variety of problems, including modeling the statistics of speech signals.

For a pair of vectors from the individual de-mixing matrices, this results in the algorithm of Equation 23:

$$Δ {w}_{ai} ∝ \frac{α}{1 - {ρ}^{2}} ( {y}_{ai} - ρ {y}_{bi} ) {( {y}_{ai}^{2} - 2 ρ {y}_{ai} {y}_{bi} + {y}_{bi}^{2} )}^{\frac{α}{2} - 1} \\ Δ {w}_{bi} ∝ \frac{α}{1 - {ρ}^{2}} ( {y}_{bi} - ρ {y}_{ai} ) {( {y}_{bi}^{2} - 2 ρ {y}_{bi} {y}_{ai} + {y}_{ai}^{2} )}^{\frac{α}{2} - 1} \qquad ( 23 )$$

where yₐᵢ=wₐᵢ^{T}xₐ is the estimated source, and is a product of the ith column vector of Wₐ with the corresponding input vector xₐ. The parameter α is a so-called “shape parameter”, which generally defines the sparseness (kurtosis) of model probability density. The other parameter ρ, is a correlation coefficient derived from the basic definition of the multivariate generalized Gaussian distribution. This parameter tends to control the degree of correlation between yₐᵢ and y_{bi}, with a large value for ρ favoring a more coherent structure being learned across the two networks, while a smaller value favors greater statistical independence within the outputs of each network.

In addition to the weight update Equation 23, each of the updated weight vectors may be subsequently normalized prior to the next iteration.

Practical Performance Issues

Combined with the use of closely-spaced directional microphones, cICA has the potential to solve some of the problem discussed above. However, there are two significant performance considerations that should be taken into account. The first is whether the use of an underlying statistical signal model affects the performance of the cICA system in more generalized environments. In addition, while the use of closely-spaced microphones tends to solve the problem of convolutive acoustic mixing, this problem may be reappear because of the use of a second pair of microphones on the other side of a wearer's head.

Copula ICA

In some embodiments, the issue of using a modeling approach for blind source separation may be looked at in isolation. In such a case, an experimental assessment may be relatively straightforward. By setting ρ=0, the algorithm of Equation 23 may adapt without regard for coherency, allowing a baseline for the evaluation of the non-coherent version of ICA algorithm (which will here be termed copula Independent Components Analysis, or coICA).

According to one experiment, two super-Gaussian signals were generated using the function of Equation 24:

sᵢ(t)=nᵢ(t)·|nᵢ(t)|^{0.1} i={1,2} (24)

where nᵢ(t) is a normally distributed random signal.

These signals were then mixed using the linear mixing model of Equation 19. For 100 random trials, the effects of three different shape parameters were compared in terms of the algorithm's ability to successfully recover the source signals. Each instance of the source signals was 10,000 samples long, and the algorithm was allowed to run for 100 iterations over the full data set with a constant learning rate of η=0.0015.

It was discovered that while convergence occurred after about 16 iterations in all cases, the quality of source separation was strongly dependent on the shape parameter used, as is generally shown below in Table 4, which shows the sensitivity of the copula method to different distributional models.

TABLE 4

| Shape | Mean Output | | Minimum | Maximum |
|---|---|---|---|---|
| Parameter (α) | SIR (dB) | Variance | SIR | SIR |
| 1.3 | 6.8 | 4.8 | 5.0 | 9.48 |
| 1.7 | 11.56 | 3.38 | 9.35 | 13.11 |
| 1.9 | 6.87 | 24.2 | 0.02 | 22.2 |

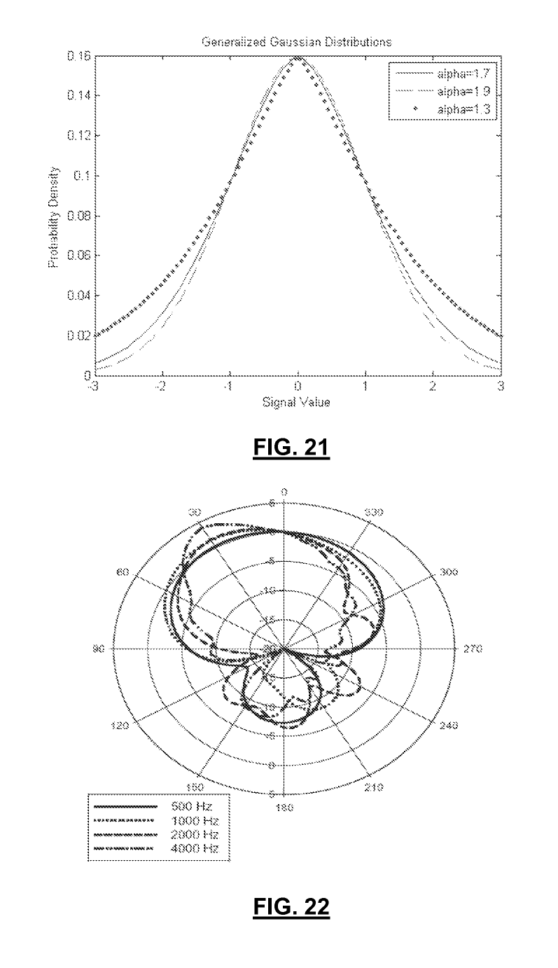

It should be noted that the differences in the modeled pdf for the values of α chosen for this experiment are generally not large. FIG. 21 shows a comparison of different generalized Gaussian probability distributions for the coICA experiment. Note the overall similarity especially for cases where alpha=1.7 and alpha=1.9. One conclusion that may be drawn is that the baseline performance for the copula version of ICA, and thus for the original formulation of cICA, is generally overly sensitive to the model distribution.

This stands in contrast to the usual formulation of ICA, which is typically only sensitive to the sign of the kurtosis (e.g. whether or not a signal is sub- or super-Gaussian). In terms of implementation in an acoustic signal processing device subject to a wide range of environments and signal types, the narrow performance range of such a formulation may be inadequate.

Coherent ICA from First Principles

In order to deal with the combined issues of convolutive mixing and to reduce the algorithm's dependence on the accuracy of an assumed statistical model, it is helpful to consider the cICA problem as it was originally defined. Equation 21 is reproduced below:

$${J}_{cICA} = I ( {x}_{a} , {y}_{a} ) + I ( {x}_{b} , {y}_{b} ) + {\sum }_{i} {λ}_{i} I ( {y}_{ai} , {y}_{bi} ) \qquad ( 21 )$$

It can be seen from Equation 21 that both of the first two terms generally concern only adjacent microphone channels. This suggests that the linear mixing assumption is still at least approximately valid, and that these terms may be replaced with any one of several well-known ICA algorithms.

In some experiments conducted, it was found that the super Gaussian forms of these algorithms were valid for typical cocktail-party environments containing both speech and music. It was also found that a windowed version of and algorithm performed well, converging substantially quicker than a natural gradient algorithm or Infomax. The gradient-based nature also tends to ensures better tracking performance than FastICA.

In practical use, it is important to properly initialize the ICA filters in order to achieve the desired performance. The initial filters should be chosen to be close to the average desired solution, in order to both minimize the convergence time, as well as to ensure that the ICA algorithm converges to the correct solution.

Initializing the ICA filters may be fairly straightforward given that the geometry of the problem. The sources ahead of the listener are considered to correspond to the target, while those emanating from behind the listener are grouped with the interference and should be eliminated.

The initial filters may be configured to reflect this fact, drawing their coefficient values from the known directivity of the microphones being employed, or else from direct experimentation on sample scenarios.

Envelope Correlation

With respect to the problem of convolutive mixing when comparing the outputs of the two microphone groups, it is generally important to reconsider what information is being compared. For example, in the case of standard ICA, where mutual information is being minimized, or in this case, maximized across channels, the problem of developing a practical coherent ICA algorithm is not an easy one.

However, the concepts of mutual information or statistical independence are concerned with high-order statistics in addition to the 1st and 2nd-order statistics used in most classical signal processing algorithms.

Since the estimation of lower-order statistical information may be faster and more robust to noise, limiting the third term of Equation 21 to only consider 2nd-order information (correlation), tends to both simplify the problem, and improve performance, as shown in Equation 25:

$${J}_{cICA} = I ( {x}_{a} , {y}_{a} ) + I ( {x}_{b} , {y}_{b} ) + {\sum }_{i} {λ}_{i} E [ {y}_{ai} {y}_{bi} ] \qquad ( 25 )$$

The resulting formula shown in Equation 25 unfortunately still tends to suffer from the problems of convolutive mixing and time-delays discussed earlier, as it uses the raw waveforms. The signal envelope should therefore be substituted in place of the raw signal in order to avoid this problem, since it is relatively robust to noise and reverberation.

For the sake of computational simplicity, the signal envelope is approximate in each individual frame as the summation of full-wave rectified elements of that frame. This results in the envelope approximation shown in Equation 26:

$${\tilde{y}}_{ai} = {\sum }_{j = 1}^{N} \vert {y}_{ai , j} \vert \qquad ( 26 )$$

where for sensor group a the N elements of the frame from the ith input channel are summed after the application of the ICA spatial filters. Applying this to the cost function of Equation 25 results in a new cost function Equation 27:

$${J}_{cICA} = I ( {x}_{a} , {y}_{a} ) + I ( {x}_{b} , {y}_{b} ) + {\sum }_{i} {λ}_{i} E [ ( {\tilde{y}}_{ai} - {μ}_{ai} ) ( {\tilde{y}}_{bi} - {μ}_{bi} ) ] \qquad ( 27 )$$

where the envelopes may be calculated as above, and the sample means of the windowed and rectified vectors may be used as the mean values in the cross-covariance term.

Unfortunately simply adapting on this cost function does not generally produce desirable results. The reason for this is that the power of the outputs are generally unconstrained, which tends to result in a constant growth of the ICA filters.

In order to solve this problem, a fourth term can be added to the cost function, which penalizes such growth by constraining the output power of the filtered signals to be close to unity.

$$min \vert 1 - {\sum }_{j = 1}^{N} {y}_{ai , j}^{2} \vert \qquad ( 28 )$$

This is somewhat similar in concept to the power constraints used in some canonical correlation analysis (CCA) algorithms.

A final cost function to be maximized can therefore be written as Equation 29:

$${J}_{cICA} = I ( {x}_{a} , {y}_{a} ) + I ( {x}_{b} , {y}_{b} ) + {\sum }_{i} {λ}_{i} E [ ( {\tilde{y}}_{ai} - {μ}_{ai} ) ( {\tilde{y}}_{bi} - {μ}_{bi} ) ] - γ {\sum }_{i} \vert 1 - {\sum }_{j = 1}^{N} {y}_{ai , j}^{2} \vert . \qquad ( 29 )$$

with the scalar term γ representing the weighting of the power constraint. Despite its apparent complexity, the resulting algorithm performs well, and still allows for fast convergence when using gradient ascent. Tests conducted in both low and high reverberation environments with different interferer locations and signal types revealed that the above algorithm's performance was more or less constant over a broad variety of conditions.

Properties of Microphones

In some embodiments, the work on cICA described above has assumed the existence of ideal microphones. By ideal, it is meant that device properties such as the directivity of the microphones do not change with frequency.

In reality, most miniature directional microphones have a directivity index and gain response that is not constant with respect to the frequency. For example, in FIG. 22, the directional response of a single omni-directional microphone is shown in relation to the source frequency. It is notable that both the microphone and the physical mounting (e.g. a user's head) can contribute to variations in directivity with frequency.

These frequency-based variations can be problematic for the straight time-domain implementation of Equation 29. In that case, a single ICA filter may be applied across all frequencies based on the assumption that the microphone response is flat.

However, experiments suggest that if this assumption is violated, then the time-domain cICA algorithm will diverge. To demonstrate this divergence, a simple simulation was conducted using data collected from the R-HINT-E corpus.

A simple filtering operation was used to alter the flat-response characteristics of the microphones into a pair of directional microphones whose directivity increases with frequency.

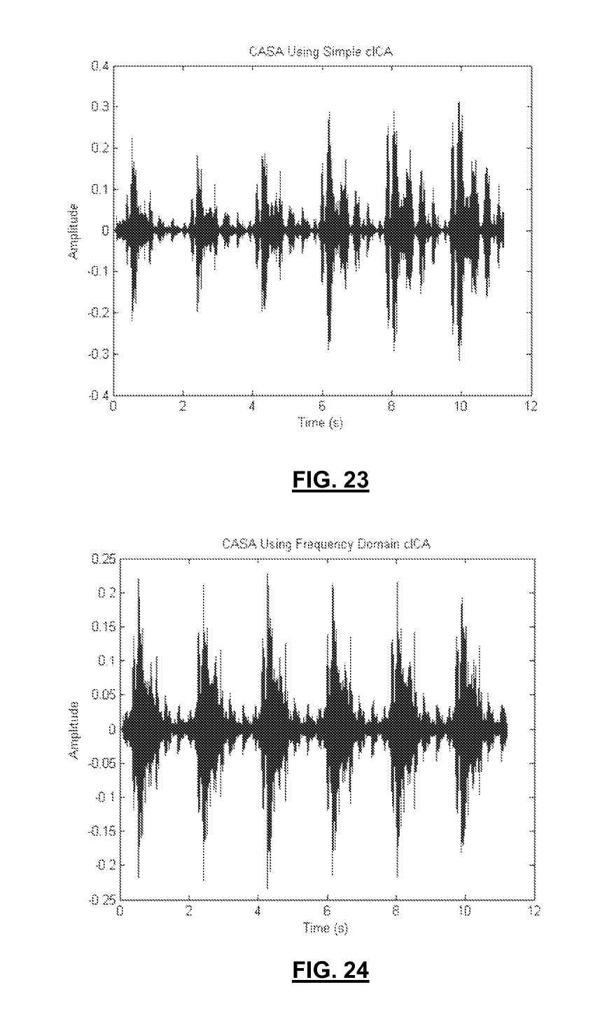

Specifically, the base directional gain was assumed to be 1 dB at 100 Hz, and then increased to a maximum directional gain of 4 dB at 1000 Hz. Over several repeated presentations of the same stimulus, as shown in FIG. 23, it is apparent that the cICA filter slowly diverges.

This problem may be fixed by applying the cost function from above in a channel-wise fashion. That is, an independent set of cICA filters can be applied to each channel or group of channels in order to inhibit the filters from diverging during adaptation, as shown in FIG. 24 for example.

One drawback is an increase in computational complexity, although this can be minimized or reduced by forcing the cICA filters to adapt to a group of channels where the microphone response is known to be similar. The placement and size of such frequency regions will vary between microphones, although in general there tends to be greater variation in the lower frequency ranges than in the higher ones.

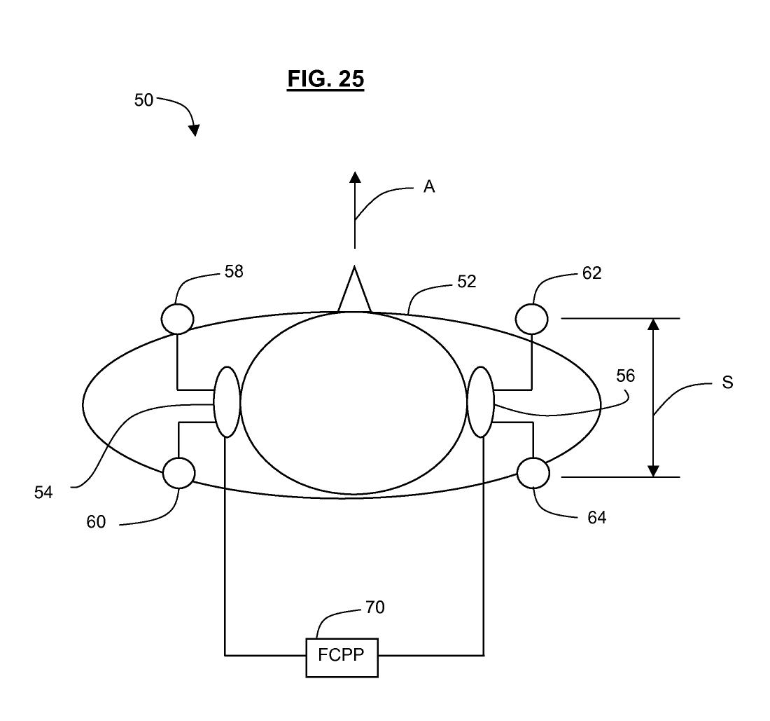

Turning now to FIG. 25, illustrated therein is an apparatus 50 for binaural hearing enhancement according to one embodiment. The apparatus 50 is generally used by a user or observer 52 who may be hearing impaired or who may otherwise desired enhanced hearing, and in some embodiments is configured as a portable system that may be worn by the observer 52. As shown, the observer 52 may be considered to be facing forward generally in the direction of the arrow A.

As shown, the apparatus 50 may generally two directional microphones (which are normally directional microphones) place on or near each of the left ear 54 and right ear 56 of the observer 52. For example, in this embodiment the left ear 54 has a left forward-facing directional microphone 58 and a left rearward-facing directional microphone 60, while the right ear 56 has a right forward-facing directional microphone 62 and a right rearward-facing directional microphone 64.

The forward-facing microphones 58, 62 are generally spaced apart from the rearward-facing microphones 60, 64 by a distance S. In some embodiments, the distance S may be large such that the forward-facing microphones 58, 62 are spaced far apart from the rearward-facing microphones 60, 64. In other embodiments, in particular in embodiments that incorporate cICA pre-processing, the distance S should be as close as practically possible.

The forward-facing microphones 58, 62 and rearward-facing microphones 60, 64 are generally coupled to an FCPP system 70. The FCPP system 70 process auditory signals received from the microphones 58, 60, 62, and 64 as generally described herein in order to reduce or eliminate background interference signals so that a target signal may be more clearly heard.

Generally, the FCPP system 70 also includes at least one output device (e.g. a speaker) provided at or near at least one of the left ear 54 and right ear 56 so that the processed target signal may be communicated to the observer 52.

While some embodiments described herein are related to hearing aid systems, the teachings disclosed herein could also be used in other auditory processing systems, including for example hearing protection devices, surveillance devices, and teleconference and telecommunications systems.

1. A system for binaural hearing enhancement, comprising:
a. at least one auditory receiver configured to receive an auditory signal that includes a target signal;
b. at least one processor coupled to the at least one auditory receiver, the at least one processor configured to:
i. extract a plurality of auditory cues from the auditory signal;
ii. prioritize at least one of the plurality of auditory cues based on the robustness of the auditory cues; and
iii. based on the prioritized auditory cues, extract the target signal from the auditory signal.

2. The system of claim 1, wherein the at least one processor is configured to extract the target signal by performing time-frequency decomposition on the auditory signal.

3. The system of claim 1, wherein the plurality of auditory cues includes at least one of: onset cues, pitch cues, interaural time delay (ITD) cues, and interaural intensity difference (IID) cues.

4. The system of claim 3, wherein onset cues and pitch cues are considered as robust cues, and ITD cues and IID cues are considered as weaker cues, and wherein the at least one processor is configured to:
a. make initial auditory groupings using the robust cues; and
b. then specifically identify the auditory groupings using the weaker cues.

5. The system of claim 1, wherein the at least one processor is further configured to:
a. group the auditory cues based on one or more fuzzy logic operations; and
b. analyze the groups to extract the target signal.

6. The system of claim 1, wherein the processor is further configured to:
a. calculate time-frequency weighting factors for the plurality of auditory cues;
b. calculate at least one smoothing parameter; and
c. perform time-smoothing over the time-frequency weighting factors based on the at least one smoothing parameter.

7. The system of claim 1, wherein the at least one auditory receiver includes at least one pair of forward facing microphones and at least one pair of rearward facing microphones.

8. The system of claim 7, wherein the at least one processor is further configured to reduce rearwards directional interference using spectral subtraction weights derived from the at least one pair of rearward facing microphones.

9. The system of claim 8, wherein the at least one processor is configured to re-synthesize the interference reduced signal and to output the resulting interference reduced signal to at least one output device.

10. The system of claim 1, further comprising a pre-processor configured to eliminate at least some interference from the auditory signal before the auditory signal is received by the at least one processor.

11. The system of claim 10, wherein the pre-processor is configured to perform independent component analysis (ICA) on the auditory signal before the auditory signal is received by the at least one processor, and wherein the at least one auditory receiver includes two closely spaced microphones.

12. The system of claim 10, wherein the pre-processor is configured to perform coherent independent component analysis (CICA) on the auditory signal before the auditory signal is received by the at least one processor.

13. The system of claim 10, wherein the pre-processor is configured to perform copula independent components analysis (coICA) on the auditory signal before the auditory signal is received by the at least one processor.

14. A method for binaural hearing enhancement, comprising:
a. receiving an auditory signal that includes a target signal;
b. extracting a plurality of auditory cues from the auditory signal;
c. prioritizing at least one of the plurality of auditory cues based on the robustness of the auditory cues; and
d. based on the prioritized auditory cues, extracting the target signal from the auditory signal.

15. The method of claim 14, wherein the target signal is extracted by performing time-frequency decomposition on the auditory signal.

16. The method of claim 14, wherein the plurality of auditory cues includes at least one of: onset cues, pitch cues, interaural time delay (ITD) cues, and interaural intensity difference (IID) cues.

17. The method of claim 16, wherein onset cues and pitch cues are considered as robust cues, and ITD cues and IID cues are considered as weaker cues, and further comprising:
a. making initial auditory groupings using the robust cues; and
b. then specifically identifying the auditory groupings using the weaker cues.

18. The method of claim 14, further comprising:
a. grouping the auditory cues based on one or more fuzzy logic operations; and
b. analyzing the groups to extract the target signal.

19. The method of claim 14, further comprising:
a. calculating time-frequency weighting factors for the plurality of auditory cues;
b. calculate at least one smoothing parameter; and
c. perform time-smoothing over the time-frequency weighting factors based on the at least one smoothing parameter.

20. The method of claim 14, further comprising:
a. providing at least one pair of rearward facing microphones; and
b. reducing rearwards directional interference using spectral subtraction weights derived from the at least one pair of rearward facing microphones.

21. The method of claim 20, further comprising:
a. re-synthesizing the interference reduced signal; and
b. outputting the resulting interference reduced signal to at least one output device.

22. The method of claim 14, further comprising pre-processing the auditory signal to eliminate at least some interference from the auditory signal before extracting the plurality of auditory cues from the auditory signal.

23. The method of claim 22, further comprising:
a. providing at least two closely spaced microphones; and
b. performing independent component analysis (ICA) on the auditory signal using the at least two closely spaced microphones before extracting the plurality of auditory cues from the auditory signal.

24. The method of claim 14, further comprising performing coherent independent component analysis (CICA) on the auditory signal before extracting the plurality of auditory cues from the auditory signal.

25. The method of claim 14, further comprising performing copula independent components analysis (coICA) on the auditory signal before extracting the plurality of auditory cues from the auditory signal.

26. An apparatus for binaural hearing enhancement, comprising:
a. at least one auditory receiver configured to receive an auditory signal that includes a target signal; and
b. at least one processor coupled to the at least one auditory receiver, the at least one processor configured to:
i. extract a plurality of auditory cues from the auditory signal;
ii. prioritize at least one of the plurality of auditory cues based on the robustness of the auditory cues; and
iii. based on the prioritized auditory cues, extract the target signal from the auditory signal.
